(19) United States
(12) Patent Application Publication
(10) Pub. No.: US 2007/0240468 A1
(43) Pub. Date: Oct. 18, 2007

(54) LOCK USAGE INDICATOR

(75) Inventor: D. Scott Kalous, Kenosha, WI (US)

Correspondence Address: CALFEE, HALTER & GRISWOLD LLP, 1400 MCDONALD INVESTMENT CENTER, 800 SUPERIOR AVENUE, CLEVELAND, OH, 44114, US

(73) Assignee: MASTER LOCK COMPANY LLC, Oak Creek, WI (US)

(21) Appl. No.: 11/736,200

(22) Filed: Apr. 17, 2007

Related U.S. Application Data
(60) Provisional application No. 60/792,530, filed on Apr. 17, 2006.

(51) Int. Cl. E05B 41/00

(52) U.S. Cl. 70/432

(57) ABSTRACT

A lock includes a lock body, a lock body engaging member, and a usage indicator. The lock body includes a sidewall portion and a lock interface. The usage indicator is assembled with the lock body and includes a spanner portion secured to the lock body by a severable seal member. The usage indicator further includes a first flanged portion extending laterally from a first end portion of the spanner portion to engage a first end face of the lock body, and a second flanged portion extending laterally from a second end portion of the spanner portion to engage at least one of the lock body engaging member and the second end face of the lock body. At least one of the spanner portion, the first flanged portion, and the second flanged portion covers the lock interface to restrict access to the lock interface.

### CROSS REFERENCE TO RELATED APPLICATION

This application claims the benefit of the U.S. Provisional Patent Application Ser. No. 60/792,530, entitled “Receiver Lock Activity Indicator” and filed Apr. 17, 2006, the entire disclosure of which is hereby incorporated by reference, to the extent that it is not conflicting with the present application.

### BACKGROUND

Trucks, sport utility vehicles, and other vehicles capable of towing trailers or other such equipment, typically include a receiver arranged to accommodate a ball mount equipped with a hitch-ball. Such a hitch-ball mount can be secured to a receiver by placing a receiver pin through pairs of mating apertures in the hitch-ball mount and receiver. The pairs of apertures can be positioned to align and accommodate the pin, which may be secured in an inserted position by a retaining clip, fastener, or other such component. As shown in FIG. 1, a receiver pin 12 may be equipped with a locking component or lock body 16 which lockingly engages the pin 12 to form a receiver lock 10 for preventing unauthorized removal of the pin 12 from the receiver, thereby securing the hitch-ball mount to the receiver (not shown). An exemplary receiver lock includes a key operated lock body 16, in which insertion and rotation of a proper key in the keyway 18 allows removal of the lock body 16 from the pin 12 to allow removal of the pin from the hitch-ball mount and receiver apertures. A protective cap 20 may be provided with the lock body to protect the keyway 18 from moisture and other contaminants. A permanently affixed head portion 14 prevents removal of the pin 12 from the apertures in an opposite direction. The head portion may alternatively comprise a bent end portion of the receiver pin or any other suitable enlarged or laterally extending projection preventing withdrawal of the head portion through the aligned apertures.

Under certain circumstances, the owner of a towing vehicle may desire to know if the receiver lock has been removed from the receiver since the vehicle was last inspected. One example of such a circumstance is a truck rental company that rents trucks with ball mounts secured to receivers on the trucks. The rental company may want to provide the renter with the key to the receiver lock for emergency purposes, but may stipulate that the receiver lock be removed only in case of an emergency. When the renter returns the truck, it may be advantageous for the rental company to be able to determine if the receiver lock was removed from the receiver by the renter. Such information may be useful, such as, for example, in investigating vehicle accidents, settling insurance claims, determining liability for damages.

### SUMMARY

The present application contemplates various inventive features for a usage indicator for a lock. While the exemplary embodiment illustrated and described herein is used with a receiver lock having a removable key operated lock body, one or more of the inventive features described herein may also be used on any number of lock assemblies, including, for example, padlocks.

According to an inventive aspect of the present application, a usage indicator may include a covering member, such as a bracket, plate, cap, or other such structure, that may be assembled over a lock body to block access to a lock interface, such as a keyway or one or more combination dials. The usage indicator may be assembled with the lock body such that a portion of the usage indicator, such as a severable seal member, must be cut, torn, or otherwise severed to move the usage indicator away from the lock interface to allow the lock to be unlocked.

Accordingly, in one embodiment of the present application, a lock includes a lock body and a usage indicator. The lock body includes a sidewall portion extending to first and second end faces; a lock interface disposed on at least one of the first end face, the second end face, and the sidewall; and a lock body engaging member extending from the second end face. The usage indicator is assembled with the lock body and includes a spanner portion having first and second end portions, the spanner portion being secured to the lock body by a severable seal member. The usage indicator further includes a first flanged portion extending laterally from the first end portion of the spanner portion to engage the first end face, and a second flanged portion extending laterally from the second end portion of the spanner portion to engage at least one of the lock body engaging member and the second end face of the lock body. At least one of the spanner portion, the first flanged portion, and the second flanged portion covers the lock interface to restrict access to the lock interface.

### BRIEF DESCRIPTION OF THE DRAWINGS

Further features and advantages of the invention will become apparent from the following detailed description made with reference to the accompanying drawings, wherein:

FIG. 1 is a perspective view of a receiver lock;

FIG. 2 is a perspective view of a usage indicator for a receiver lock;

FIG. 3 is a perspective view of the usage indicator of FIG. 2 assembled with a receiver lock; and

FIG. 4 is another perspective view of the usage indicator and receiver lock of FIG. 3.

### DETAILED DESCRIPTION

The Detailed Description of the Invention merely describes preferred embodiments of the invention and is not intended to limit the scope of the specification or claims in any way. Indeed, the invention as described is broader than and unlimited by the preferred embodiments, and the terms in the claims have their full ordinary meaning.

This invention and disclosure are directed to methods and devices for identifying access to or usage of a lock, such as, for example, a receiver lock secured to a receiver on a vehicle. Such usage includes, for example, removal of a receiver lock from a receiver on a towing vehicle or attempts to manipulate a lock interface in an effort to remove the lock. When the lock is inspected regularly, an indication of usage can be evidence of the individuals or circumstances involved in the alleged usage. For example, if a single person was responsible for or had possession of the lock between two inspection points, an indication of lock usage at the second inspection point is evidence that usage of the lock occurred while the lock was under the control of the responsible person.

The present application describes inventive features for providing visual indication of usage of a lock, such as, for example, usage of a receiver lock to unhitch a trailer from a vehicle. According to an inventive aspect of the present application, a usage indicator may be assembled with a lock body to cover a lock interface (for example, a keyway or combination dial) such that the lock cannot be unlocked without moving or removing the usage indicator. The usage indicator may be assembled with the lock body using a severable seal member, such that removal of the usage indicator from the lock body requires severing the seal member. Examples of severable seal members include continuous bands, zip ties, adhesive seals, shrink-wrapped coverings, or other such components, which may require permanently cutting, tearing, breaking or otherwise severing the seal member, such that the seal member may not be reused to affix the usage indicator to the lock body without some visual indication of prior removal. As used herein, the term permanently severable describes a seal member that may not be readily reformed or reassembled for connecting with the lock body, without some visual indication that the seal member had been severed and reformed.

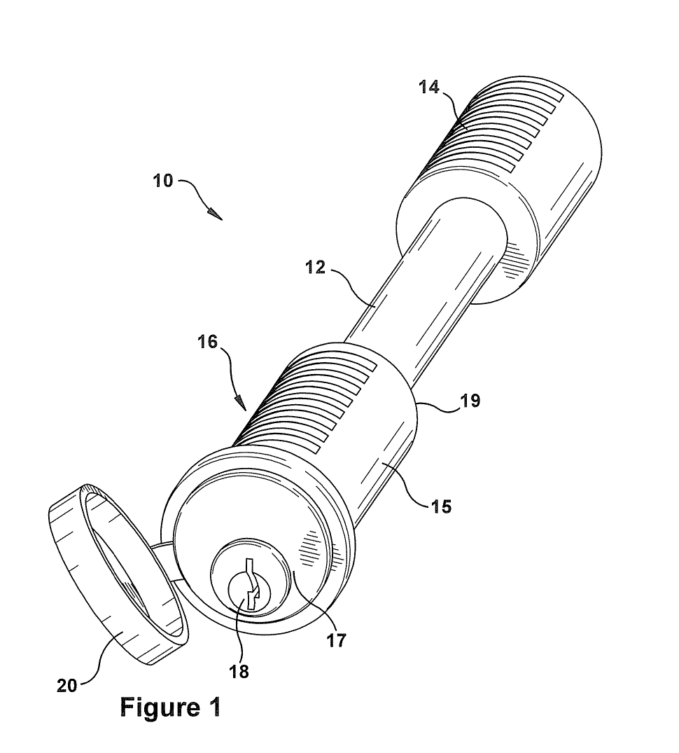

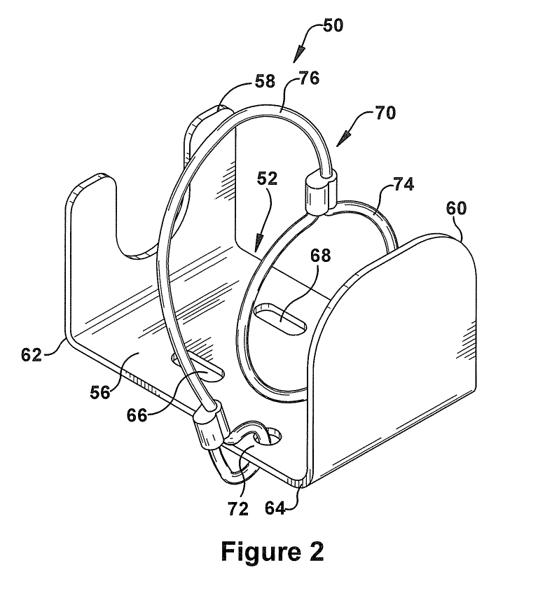

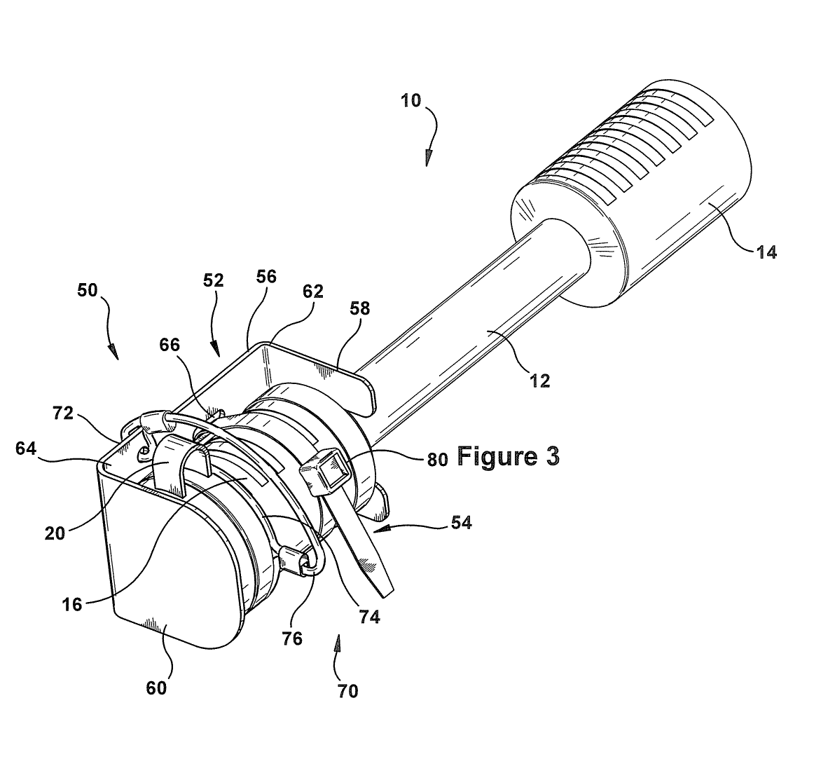

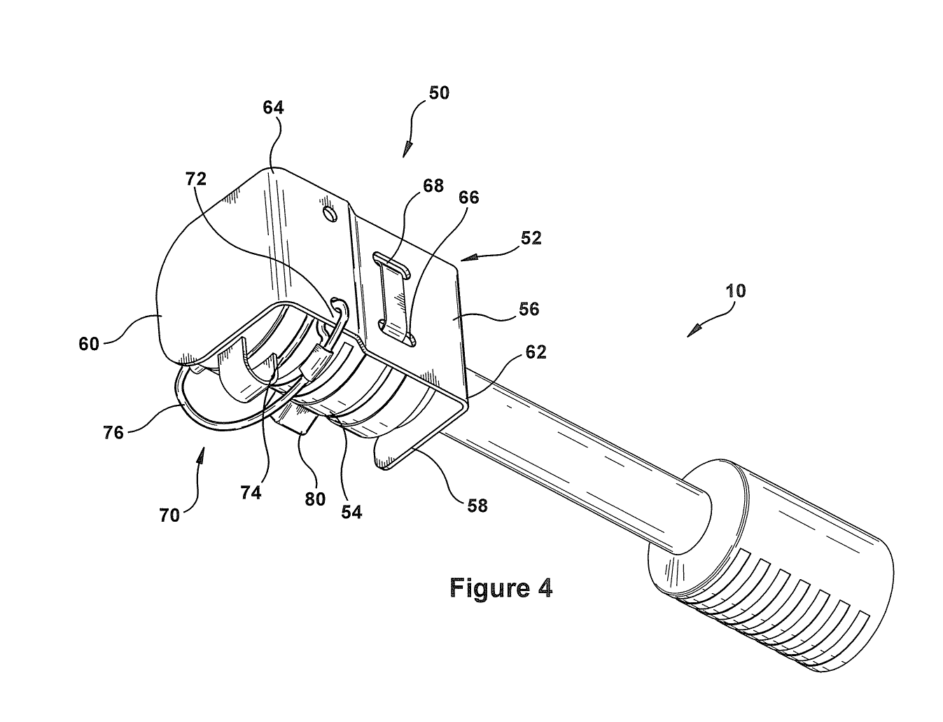

A usage indicator may be provided in many different shapes, configurations, and combinations, for assembly with many different types of locks. In one embodiment, a usage indicator may be configured for assembly with a lock body having a side wall extending to first and second end faces, with a lock interface disposed on at least one of the first end face, the second end face, and the side wall, and a lock body engaging member extending from the second end face of the lock body. As one example, a usage indicator is configured for assembly with a receiver lock 10 (see FIG. 1) having a lock body 16 with a side wall 15 extending to first and second end faces 17, 19, with a keyway 18 disposed on the first end face 17 and a locking member (such as a shackle or receiver pin 12) extending from the second end face 19. In one embodiment, as shown in FIGS. 2-4, a usage indicator 50 may include a covering member for assembly with a lock body 16 of a receiver lock 10 to cover and restrict access to the lock interface. The exemplary usage indicator 50 includes a bracket shaped member 52 and a seal member 54 (seen in FIGS. 3 and 4). In other embodiments, the covering member may include other structures, such as, for example, a plate, cap, adhesive, or band. In some embodiments, the covering member may be integral with the seal member.

The bracket shaped member 52 of the illustrated embodiment is sized to fit onto the lock body 16 to cover the lock interface 18. The bracket shaped member 52 includes a spanner portion 56, and first and second flanged portions 60, 58 extending laterally from first and second end portions 64, 62 of the spanner portion 56. The first flange portion 60 covers, contacts, or otherwise engages a first end face 17 of the lock body 16, while the second flange portion 58 covers, contacts, or otherwise engages at least one of a second end face 19 and a locking member (such as, for example, a shackle or retainer pin 12) extending from the second end face 19. As shown, the second flange portion 58 may be shaped to accommodate the receiver pin 12, for example, with a U-shape. When the bracket-shaped member 52 of the usage indicator is fitted on the lock body 16, the U-shaped second flange portion 58 fits around the pin 12 where the pin 12 enters the lock body 16, and the first flange portion 60 covers the keyway 18 such that a key cannot be inserted into the keyway 18 when the bracket-shaped member 52 is assembled onto the lock body 16.

The spanner portion 56 is configured to accommodate at least one seal member 54 (such as, for example, a one way cable tie or zip tie), which may be wrapped around a portion of the spanner portion 56 and the lock body 16 to secure the bracket shaped member 52 to the lock body 16 in an orientation covering the lock interface or keyway 18. The spanner portion 56 may be provided with a variety of shapes or configurations for accommodating the seal member 54, including, for example, one or more notches, cutouts, hooks, loops or openings for receiving the seal member therethrough, such that the seal member 54 may not be slid or slipped off of the lock body 16 and bracket shaped member 52. In the illustrated embodiment, the spanner portion 56 includes first and second openings or slots 66, 68 sized to accommodate one or more of a variety of suitable seal members. The seal member 54 may be configured such that it may be tightened around the lock body 16 and spanner portion 56 while being prevented from loosening, thereby requiring that the seal member 54 be cut, torn, or otherwise severed to remove the usage indicator 50 from the lock body 16 for access to the keyway. While many different types of seal members may be utilized, in the exemplary embodiment, the seal member 54 comprises a cable tie or zip tie fastened into a loop or ring shape around the lock body 16 and spanner portion 56. As best seen in FIG. 3, the exemplary zip tie 54 includes a ratcheting clasp 80, as known in the art, which prevents loosening of the zip tie once it has been tightened around the lock body 16 and spanner portion 56.

By requiring that the seal member 54 be permanently severed to access the keyway, a visual indication of access to the keyway (or “usage” of the lock) may be provided, as the severed seal member may not be adequately repaired or reformed for reassembly with the bracket shaped member 52 and lock body 16 without some visual indication that the seal member 54 has been compromised. To distinguish the severed seal member 54 from a replacement seal member installed by an individual with access to the lock, the original or authorized seal member may be provided with a distinguishing or source identifying feature, such as, for example, an identifiable marking (such as a code, symbol, or logo) or a non-standard color or material. The seal member 54 may be constructed of many different suitable materials, including, for example, nylon.

The usage indicator 50 may also include a tether arrangement, such that the bracket shaped member 52 remains connected with the lock 10 after the seal member 54 has been severed, for example, to prevent loss of the bracket member 52. In the illustrated embodiment, the usage indicator 50 includes a lanyard 70 coupled to an aperture 72 in the main body 56 of the bracket 52. The lanyard 70 may be fabricated from a durable material that is less susceptible to accidental or intentional damage, such as, for example, a metal wire. The lanyard 70 may be manipulated to form a loop 74 and a connecting wire 76 to secure the loop 74 to the bracket 52. As seen in FIGS. 3 and 4, the loop 74 is sized to fit tightly around the lock body 16. This arrangement secures the bracket 52 to the lock body 16 and insures that the bracket shaped member 52 is not lost or misplaced when the bracket shaped member 52 is no longer secured to the lock body 16 with the seal member 54. Although the lanyard 70 is described as being fabricated from metal wire, a tether mechanism may be fabricated or made from any suitable material and be configured in any way that maintains a connection between the bracket member 52 and the lock body 16.

The bracket shaped member 52 may be constructed using many different materials or manufacturing techniques, including, for example, fabrication from a flat metal sheet by bending the metal sheet to form first and second flange portions 58 and 60. The slots 66 and 68 and tether aperture 72 may be stamped or cut into the metal sheet. As another example, the bracket shaped member may be formed from injection or compression molded plastic.

Although the indicator strap has been illustrated and described as a one-way cable tie, indicator straps or general methods of indicating activity regarding the receiver lock are not limited in any way to one-way cable ties. Any apparatus or method that allows an inspector to discern whether an indicator mechanism has been altered in any way is included in this invention. For example, tape or adhesive strips that can only be adhered once can be utilized in accordance with the present invention. In another example, plastic sheeting can be shrink wrapped over a bracket to form an indicator mechanism.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions--such as alternative materials, structures, configurations, methods, circuits, devices and components, software, hardware, control logic, alternatives as to form, fit and function, and so on--may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A lock comprising:
a lock body comprising:
a sidewall portion extending to first and second end faces; and
a lock interface disposed on at least one of the first end face, the second end face, and the sidewall portion;
a lock body engaging member extending from the second end face; and
a usage indicator assembled with the lock body, the usage indicator comprising:
a spanner portion including first and second end portions, the spanner portion being secured to the lock body by a severable seal member;
a first flanged portion extending laterally from the first end portion of the spanner portion to engage the first end face of the lock body; and
a second flanged portion extending laterally from the second end portion of the spanner portion to engage at least one of the lock body engaging member and the second end face of the lock body;
wherein at least one of the spanner portion, the first flanged portion, and the second flanged portion covers the lock interface to restrict access to the lock interface.

2. The lock of claim 1, wherein the spanner portion comprises first and second openings for receiving the severable seal member therethrough.

3. The lock of claim 1, further comprising a lanyard having a first end connected with the lock body and a second end connected with the usage indicator for retaining the usage indicator with the lock body.

4. The lock of claim 1, wherein the second flanged portion comprises a U-shaped flange for engaging the second end face of the lock body around the lock body engaging member.

5. The lock of claim 1, wherein the lock body engaging member comprises a receiver pin.

6. The lock of claim 1, wherein the severable seal member comprises a zip tie.

7. The lock of claim 1, wherein the severable seal member is ring shaped.

8. The lock of claim 1, wherein the severable seal member includes a source identification feature.

9. The lock of claim 8, wherein the source identification feature comprises a color.

10. The lock of claim 8, wherein the source identification feature comprises a marking.

11. The lock of claim 1, wherein the lock interface is disposed on the first end face and is covered by the first flanged portion.

12. The lock of claim 1, wherein the lock interface comprises a keyway.

13. A method of limiting usage of a lock including a lock body having a sidewall portion extending to first and second end faces and a lock interface disposed on at least one of the first end face, the second end face, and the sidewall portion, the method comprising:
assembling a usage indicator with the lock body such that the usage indicator covers the lock interface to restrict access to the lock interface; and
securing a spanner portion of the usage indicator to the lock body with a severable seal member, such that the seal member must be severed to move the first flanged portion away from the lock interface.

14. The method of claim 13, wherein securing a spanner portion of the usage indicator to the lock body with a severable seal member comprises looping the severable seal member through first and second openings in the spanner portion.

15. The method of claim 13, further comprising affixing the usage indicator to the lock body with a lanyard, such that the usage indicator remains connected to the lock body when the severable seal member is severed.

16. The method of claim 13, further comprising providing the severable seal member with a source identification feature to facilitate identification of reattachment of the usage indicator with another severable seal member.

17. The method of claim 13, wherein assembling the usage indicator with the lock body comprises covering the lock interface with a first flanged portion of the usage indicator.

18. A method of identifying usage of a receiver lock for assembly with a trailer hitch, the receiver lock including a lock body having a sidewall portion extending to first and second end faces, a keyway disposed on the first end face, and a receiver pin extending from the second end face when the receiver pin is in locking engagement with the lock body, the method comprising:
inserting the receiver pin through aligned holes of a trailer hitch and a receiver;
lockably engaging the lock body with the receiver pin;
covering the keyway with a covering member;
securing the covering member to the lock body with a permanently severable seal member; and
inspecting the covering member and lock body for evidence that the permanently severable seal member has been severed, damaged, or replaced.

19. The method of claim 18, further comprising providing the permanently severable seal member with a source identification feature.

20. The method of claim 18, wherein the seal member is separate from the covering member.

21. A usage indicator for assembly with a lock body, the usage indicator comprising:
a spanner portion including first and second end portions, the spanner portion being secured to the lock body by a severable seal member;
a first flanged portion extending laterally from the first end portion of the spanner portion; and
a second flanged portion extending laterally from the second end portion of the spanner portion;
wherein at least one of the spanner portion, the first flanged portion, and the second flanged portion covers a lock interface in the lock body to restrict access to the lock interface.
